(19) United States
(12) Patent Application Publication
(10) Pub. No.: US 2025/0321715 A1
(43) Pub. Date: Oct. 16, 2025

(54) CODE BLOCK REFACTORING ENABLING COEXISTENCE OF SOURCE CODE AND UPDATED CODE

(71) Applicant: International Business Machines Corporation, Armonk, NY (US)

(72) Inventors: Vini Kanvar, Noida (IN); ShivalI Agarwal, Ghaziabad (IN); Rahamim Katan, Modiin (IL)

(21) Appl. No.: 18/632,035

(22) Filed: Apr. 10, 2024

(51) Int. Cl. G06F 8/30; G06F 11/36

(52) U.S. Cl. CPC G06F 8/30; G06F 11/3608

(57) ABSTRACT

A computer-implemented method, according to one approach, is for refactoring a number of source code blocks. The computer-implemented method includes evaluating the source code blocks and identifying dependent and exclusive ones of the source code blocks. The exclusive source code blocks are automatically refactored and options outlining how the dependent source code blocks can be refactored are generated. Moreover, the generated options are transmitted to a user. In response to receiving a selection of one or more of the options from the user, the dependent source code blocks are refactored as outlined in the selected one or more options. Furthermore, the refactored exclusive source code blocks and refactored dependent source code blocks are combined to form an updated application and corresponding updated service.

### BACKGROUND

The present invention relates to computer code, and more specifically, this invention relates to seamlessly performing code updates.

Computer code (or “code”) refers to a set of instructions, or a system of rules, written in a particular programming language. Code can also refer to source code after it has been processed by a compiler and made ready to run on the computer. In addition to building computer programs and mobile applications, code is used heavily for innovative concepts such as artificial intelligence and machine learning.

Although code is developed in a particular configuration and/or for a particular application, it can be updated over time. An update to the code involves performing changes to the code itself that impact how the code operates. In other words, new code is used to replace older versions of code. These changes to the software are usually performed to fix bugs, address security vulnerabilities, provide new features, etc. For example, updating your operating system brings it up-to-date with the latest drivers, system utilities, and security software.

While performing updates to code allows for the code to adapt over time, the update process itself is complex. For instance, performing code updates gives rise to the issue of “co-existence” between source code and at least partially updated code, which has been a particularly difficult issue for conventional products to reconcile. As an example, modernized functions may rely on external dependencies that the source code does not. The process of managing these dependencies and ensuring they do not conflict while integrating modernized code can thereby be demanding.

Integrating modernized functions with source code can also lead to compatibility issues. As another example, source code may rely on outdated libraries, frameworks, and/or APIs that modernized code does not support. Ensuring consistency in coding style and practices between the source code and modernized code has also been a challenge. Accordingly, there exists a need to develop an intelligent system capable of seamlessly implementing code updates that involve co-existence between source code and at least partially updated code.

### SUMMARY

A computer-implemented method (CIM), according to one approach, is for refactoring a number of source code blocks. The CIM includes evaluating the source code blocks and identifying dependent and exclusive ones of the source code blocks. The exclusive source code blocks are automatically refactored and options outlining how the dependent source code blocks can be refactored are generated. Moreover, the generated options are transmitted to a user. In response to receiving a selection of one or more of the options from the user, the dependent source code blocks are refactored as outlined in the selected one or more options. Furthermore, the refactored exclusive source code blocks and refactored dependent source code blocks are combined to form an updated application and corresponding updated service.

A computer program product (CPP), according to another approach is for refactoring a number of source code blocks. The CPP includes a set of one or more computer-readable storage media, along with program instructions that are collectively stored in the set of one or more storage media, and are for causing a processor set to perform the combinations of the foregoing methodologies.

A computer system (CS), according to yet another approach, includes: a processor set, and a set of one or more computer-readable storage media. The CS also includes program instructions that are collectively stored in the set of one or more storage media, and are for causing the processor set to perform the combinations of the foregoing methodologies to refactor a number of source code blocks.

A CIM according to another approach, is for refactoring a number of source code blocks. The CIM includes submitting a request to refactor the source code blocks, the source code blocks including standard code and/or partially updated polyglot code. Moreover, options which outline how dependent ones of the source code blocks can be refactored are received. The received dependent source code blocks may include shared dependent blocks and/or cross-dependent blocks. In response to selecting one or more of the options outlining how dependent ones of the source code blocks can be refactored, the dependent source code blocks are refactored as outlined in the selected one or more options. Furthermore, the refactored dependent source code blocks are combined with refactored exclusive source code blocks to form an updated application and corresponding updated service.

A CPP according to still another approach, is for refactoring a number of source code blocks. The CPP includes a set of one or more computer-readable storage media. The CPP also includes program instructions that are collectively stored in the set of one or more storage media, and are for causing a processor set to perform the combinations of the foregoing methodologies.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of an incremental source code refactoring process, in accordance with one approach.

FIG. 3A is a flowchart of a method, in accordance with one approach.

FIG. 3B is a flowchart of sub-operations for one of the operations in the method of FIG. 3A, in accordance with one approach.

FIG. 3C is a representational view of how code refactoring options may be produced in accordance with an in-use example.

FIG. 4A is a representational view of a progression implementing incremental service extraction, in accordance with an in-use example.

FIG. 4B is a representational view of progressions depicting shared vs. non-shared dependent code blocks, in accordance with an in-use example.

FIG. 4C is a representational view of progressions depicting variable dependent vs. variable exclusive code blocks in accordance with an in-use example.

FIG. 4D is a representational view of a progression depicting control dependent code blocks in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for refactoring a number of source code blocks in such a way that seamlessly enables the co-existence of source code and updated code. Approaches herein are able to perform the refactoring more efficiently than previously achievable by systematically refactoring extracted services as well as source code from which the services are extracted in incremental steps. The approaches are thereby able to address co-existence challenges within systems by ensuring mutual consistency between the source code and any extracted services. Moreover, approaches are capable of refactoring pure legacy code and/or partially updated polyglot legacy code in a manner that enables co-existence with the updated logic of the legacy application that have cross and/or shared dependencies, e.g., as will be described in further detail below.

In one general approach, a CIM is for refactoring a number of source code blocks. The CIM includes evaluating the source code blocks and identifying dependent and exclusive ones of the source code blocks. The exclusive source code blocks are automatically refactored and options outlining how the dependent source code blocks can be refactored are generated. Moreover, the generated options are transmitted to a user. In response to receiving a selection of one or more of the options from the user, the dependent source code blocks are refactored as outlined in the selected one or more options. Furthermore, the refactored exclusive source code blocks and refactored dependent source code blocks are combined to form an updated application and corresponding updated service.

It follows that various approaches herein are desirably able to automatically refactor either pure legacy code or partially updated polyglot legacy code to enable co-existence with the updated logic of the legacy application that have cross and/or shared dependencies. This refactoring process is performed incrementally and continuously until the desired updated state is achieved. Co-existence is achieved by approaches herein by automatically identifying code blocks that cannot be extracted, e.g., such as dependent code blocks that cannot be easily removed from the original application and placed into a new service. These approaches area able to recognize shared dependent code blocks as well as cross-dependent code blocks (in terms of variable usage as well as control flow). Moreover, one or more AI based models may be used to generate a number of options outlining different ways that dependent code blocks may be refactored to enable co-existence, e.g., as would be appreciated by one skilled in the art after reading the present description.

In some implementations, each of the source code blocks are evaluated for code blocks of interest. In some approaches a starting block of a service is a block of interest. Thus, a determination may be made as to whether a given source code block is a starting block of a service. In response to determining the given source code block is the starting block of a service, the given source code block is replaced with a call to the service. In other approaches, a dependent code block is a block of interest. Thus, a determination may be made as to whether a given source block is a dependent block, and if so, whether the dependent source code blocks is a shared dependent block and/or a cross-dependent block. In such approaches, a warning may be produced in response to determining a given dependent source code block is a cross-dependent source code block. The warning preferably outlines that the given dependent source code block will be added to the updated service.

It follows that approaches herein are desirably able to merge codependent source code with selected code and/or services without blindly automating the process. For instance, blind deletion of shared dependent source code blocks is undesirable. Rather, suggested refactoring alternates may be used to ultimately refactor one or more of the shared dependent source code blocks, e.g., as described herein. Approaches herein are also desirably able to automatically refactor either pure legacy code or partially updated polyglot code to enable co-existence with the updated logic of the legacy application that have cross and/or shared dependencies. This refactoring process is performed incrementally and continuously until the desired updated state is achieved.

In some implementations, one or more refactoring alternates are produced in response to determining a given dependent source code block is a shared dependent source code block. The one or more refactoring alternates that are produced may include, but are in no way limited to, duplicating the given dependent source code block, using the given dependent source code block to produce a new service, creating conditional execution of the given dependent source code block, and hoisting the given dependent source code block.

The options (also referred to herein as “alternates”) are preferably generated such that they outline refactoring steps that support the co-existence of source code and updated code while also maintaining functionality of the code as a whole, allowing for improved software modernization. In other words, the options that are produced outline how a code block (e.g., dependent code block) can be refactored to support co-existence of source code and updated code. In some approaches, at least some of the options may be generated (e.g., output) by one or more trained AI based models that are configured to evaluate source code blocks (e.g., code blocks of interest) and generate possible ways of refactoring the code blocks based on how code is being updated.

In some implementations, source code blocks determined as including initializations are refactored by being duplicated into the updated application. In other implementations, source code blocks determined as including a number of lines therein that is outside a predetermined range are refactored by being duplicated into the updated application.

It follows that additional considerations may be taken into consideration while determining how a code block is ultimately refactored. For example, certain code blocks may be sufficiently small that simply copying them into the updated code is simpler than evaluating how it should be refactored. Accordingly, a size of each code block evaluated may be compared against a predetermined range to determine whether the code block is small enough to forego further evaluation. Similarly, certain types of code blocks may be simply copied into updated code. For example, code blocks that include initializations are preferably maintained even in the updated code. Accordingly, the type of each code block evaluated may be inspected to determine whether the code block should simply be copied, or refactored using different steps, e.g., as would be appreciated by one skilled in the art after reading the present description.

In another general approach, a CPP is for refactoring a number of source code blocks. The CPP includes a set of one or more computer-readable storage media, along with program instructions that are collectively stored in the set of one or more storage media, and are for causing a processor set to perform the combinations of the foregoing methodologies.

In still another general approach, a CS includes: a processor set, and a set of one or more computer-readable storage media. The CS also includes program instructions that are collectively stored in the set of one or more storage media, and are for causing the processor set to perform the combinations of the foregoing methodologies to refactor a number of source code blocks.

In another general approach, a CIM is for refactoring a number of source code blocks. The CIM includes submitting a request to refactor the source code blocks, the source code blocks including standard code and/or partially updated polyglot code. Moreover, options which outline how dependent ones of the source code blocks can be refactored are received. The received dependent source code blocks may include shared dependent blocks and/or cross-dependent blocks. In response to selecting one or more of the options outlining how dependent ones of the source code blocks can be refactored, the dependent source code blocks are refactored as outlined in the selected one or more options. Furthermore, the refactored dependent source code blocks are combined with refactored exclusive source code blocks to form an updated application and corresponding updated service.

Approaches herein are able to achieve co-existence by automatically identifying code blocks that cannot be extracted, e.g., such as dependent code blocks that cannot be easily removed from the original application and placed into a new service. These approaches area able to recognize shared dependent code blocks as well as cross-dependent code blocks (in terms of variable usage as well as control flow). Moreover, approaches are desirably able to merge codependent source code with selected code and/or services without blindly automating the process. For instance, blind deletion of shared dependent source code blocks is undesirable. Rather, suggested refactoring alternates may be used to ultimately refactor one or more of the shared dependent source code blocks as described herein.

In still another general approach, a CPP is for refactoring a number of source code blocks. The CPP includes a set of one or more computer-readable storage media. The CPP also includes program instructions that are collectively stored in the set of one or more storage media, and are for causing a processor set to perform the combinations of the foregoing methodologies.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved block update code at block 150 for refactoring a number of source code blocks in such a way that seamlessly enables the co-existence of source code and updated code. Approaches herein are able to perform the refactoring more efficiently than previously achievable by systematically refactoring extracted services as well as source code from which the services are extracted in incremental steps, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

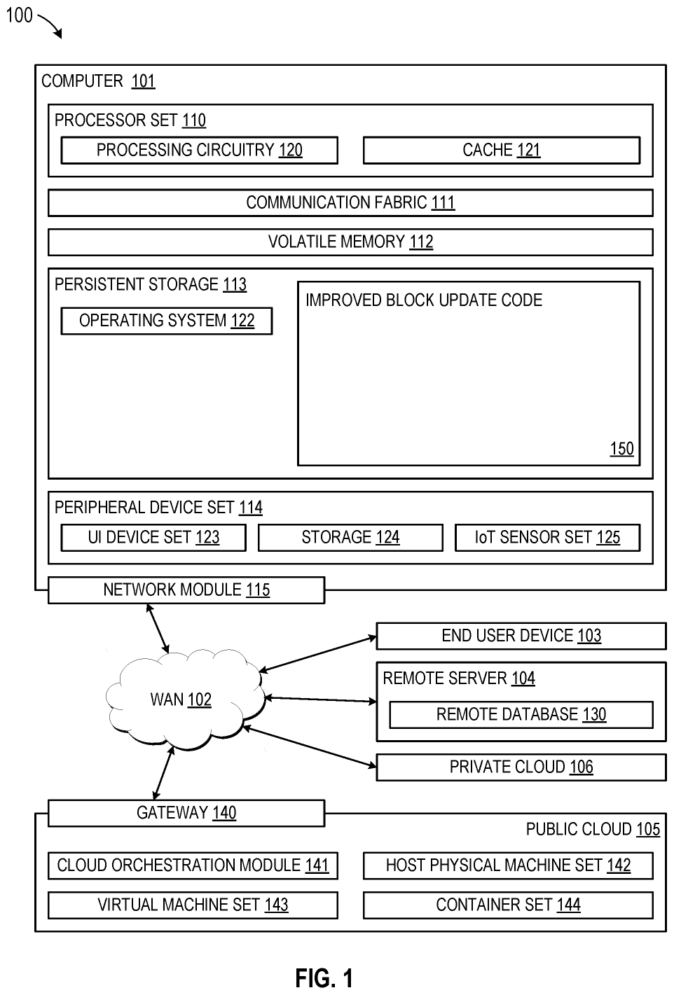

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, computer code refers to a set of instructions, or a system of rules, written in a particular programming language, also referred to as “source code”. Code is also the term used for the source code after it has been processed by a compiler and made ready to run on the computer. In addition to building computer programs and mobile applications, code is used heavily for innovative concepts such as artificial intelligence and machine learning.

Although code is developed in a particular configuration and/or for a particular application, it can be updated over time. An update to the code involves performing changes to the code itself that impact how the code operates. In other words, new code is used to replace older versions of code. These changes to the software are usually performed to fix bugs, address security vulnerabilities, provide new features, etc. For example, updating your operating system brings it up-to-date with the latest drivers, system utilities, and security software.

While performing updates to code allows for the code to adapt over time, updates are also a significant source of operating strain. For instance, updated portions of code (e.g., new code) are ideally integrated with existing code without changing the overall function of the existing code. For example, code refactoring includes restructuring the architecture of a program or application without changing its base functionality. This is an extremely complex process that involves newly formed services and modernized code operatively co-existing with source code.

This issue of “co-existence” between source code (also referred to herein as “legacy code”) and at least partially updated (also referred to herein as “modernized”) code has been a particularly difficult issue to solve for conventional products. According to an example, modernized functions may rely on external dependencies that the source code does not. The process of managing these dependencies and ensuring they do not conflict while integrating modernized code can be a complex process. Integrating modernized functions with source code can also lead to compatibility issues. For instance, source code may rely on outdated libraries, frameworks, and/or APIs that modernized code does not support. Ensuring consistency in coding style and practices between the source code and modernized code has also been a challenge for conventional products.

These co-existence issues are apparent in situations where conventional products attempt refactoring. As noted above, refactoring is a complex process that involves several different considerations, particularly with dependent sections of code. Dependent code blocks are difficult to remove from the original application without altering the behavior of the application. Thus, a determination is made as to which dependent code blocks should be incorporated into a service as a result of refactoring. To further complicate matters, an application is refactored differently in situations where code blocks of interest are included in the service as well as other sections of code. The refactoring may also introduce new coding standards to enforce, further impacting the integration of any modernized code.

Conventional products have thereby struggled to implement code updates and suffer from significant latency issues as a result. These conventional products have had difficulty maintaining operational relevance, being forced to choose between high latency caused by diverting throughput to implement updates, and outdated or unsupported operating procedures caused by foregoing code updates to maintain desirable input/output (I/O) rates. Conventional products have thereby struggled with replacing code seamlessly and reliably, including replacing references to a piece of code after it has been updated.

In sharp contrast, approaches herein address the long-standing issue of achieving refactoring that incorporates co-existence of source code and updated code. In some approaches, this is achieved at least in part by systematically refactoring extracted services, as well as the source code itself. This refactoring is performed in incremental steps such that the source code is processed gradually over several iterations. This desirably ensures a mutual consistency between the source code and any extracted services, e.g., as will be described in further detail below.

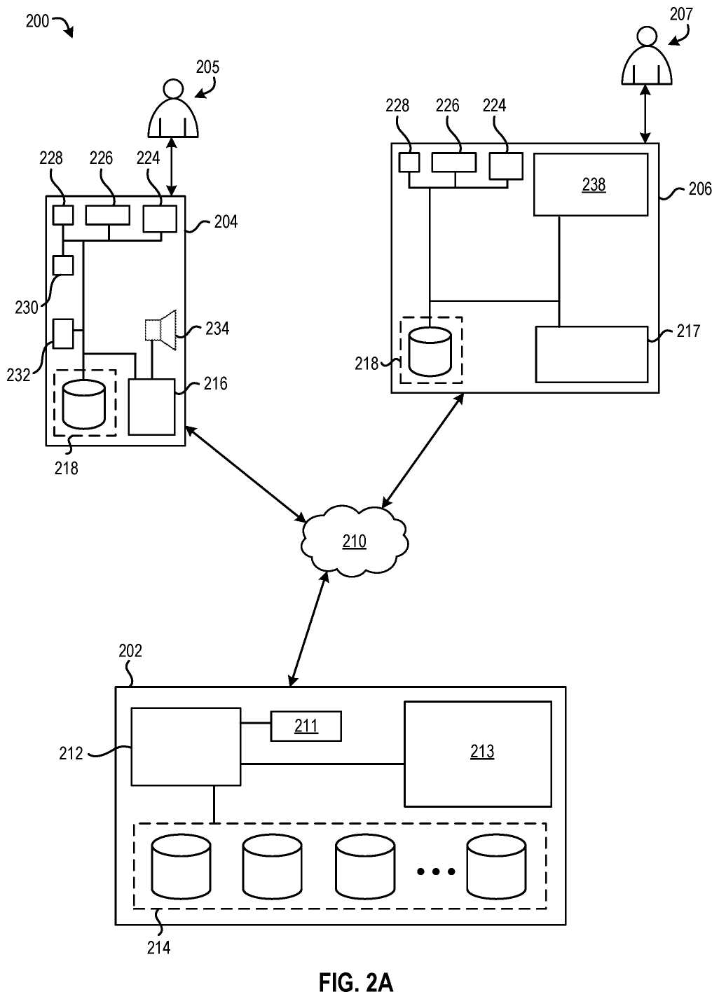

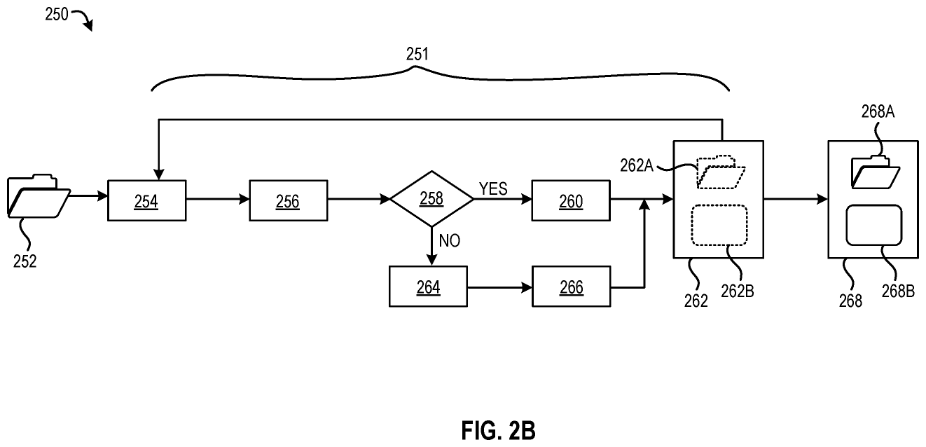

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206. The user device 204 is further accessible to the user 205, while the edge node 206 is assessable to developer 207. The user device 204 and/or the edge node 206 may thereby be considered “client devices,” each of which are connected to the central server 202.

The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “developer” are in no way intended to be limiting. For instance, while users and developers may be described as being individuals in various implementations herein, a user and/or a developer may be an application, an organization, a preset process, etc. in other approaches. The use of “code,” “data,” and “information” herein are in no way intended to be limiting either, and may include any desired type of details, e.g., depending on the type of operating system implemented on the user device 204, edge node 206, and/or central server 202.

With continued reference to FIG. 2A, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 includes models that have been trained to assist in updating code blocks (also referred to herein as “modules”) as described herein. For instance, the AI module 213 preferably includes AI based models that have been trained to identify dependent code blocks and generate options outlining how each dependent code block may be refactored such that co-existence of source code and updated code is maintained. It follows that dependent blocks may be identified using program analysis techniques (e.g., static and/or dynamic) as well as using trained AI models.

In some approaches, the AI module 213 may work along with processor 212 to perform refactoring on source code blocks such that software updates can be made seamlessly and efficiently. For instance, the AI module 213 and/or processor 212 may be configured to inspect source code and automatically identify dependent blocks in the source code. Moreover, the dependent blocks may be identified in the source code incrementally as a result of repeatedly evaluating the code. The source code may be stored in the data storage array 214, received from user device 204 and/or edge node 206, accessed at remote location connected to network 210, etc. The AI module 213 and/or processor 212 may further be configured to generate options (e.g., recommendations) outlining how each of the identified dependent blocks may be refactored such that the resulting code functions as intended.

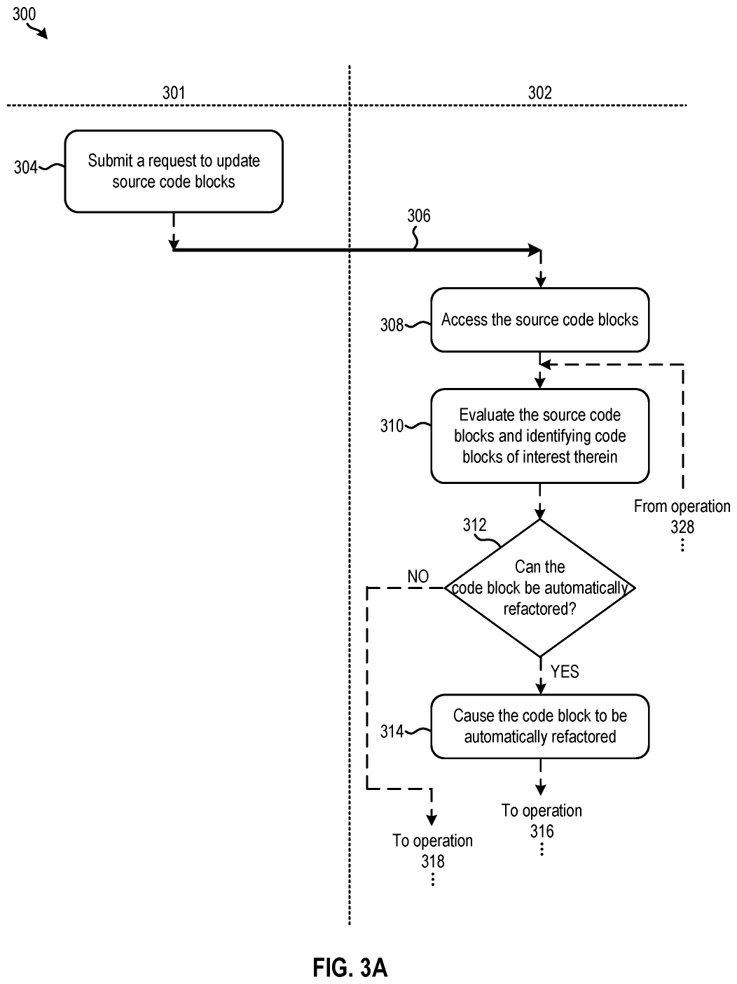

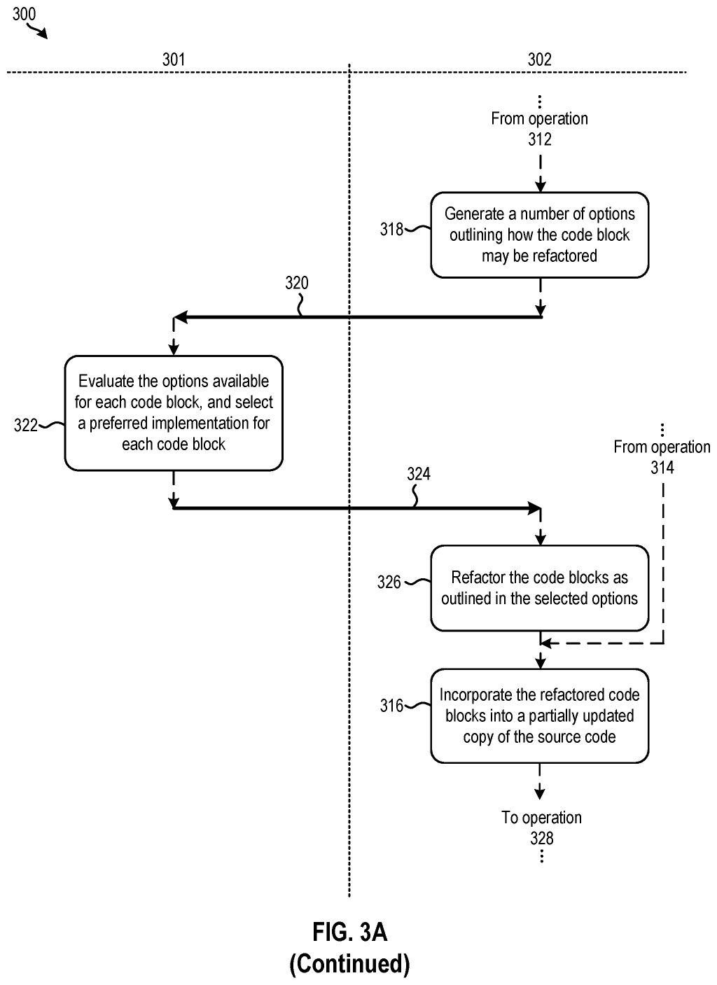

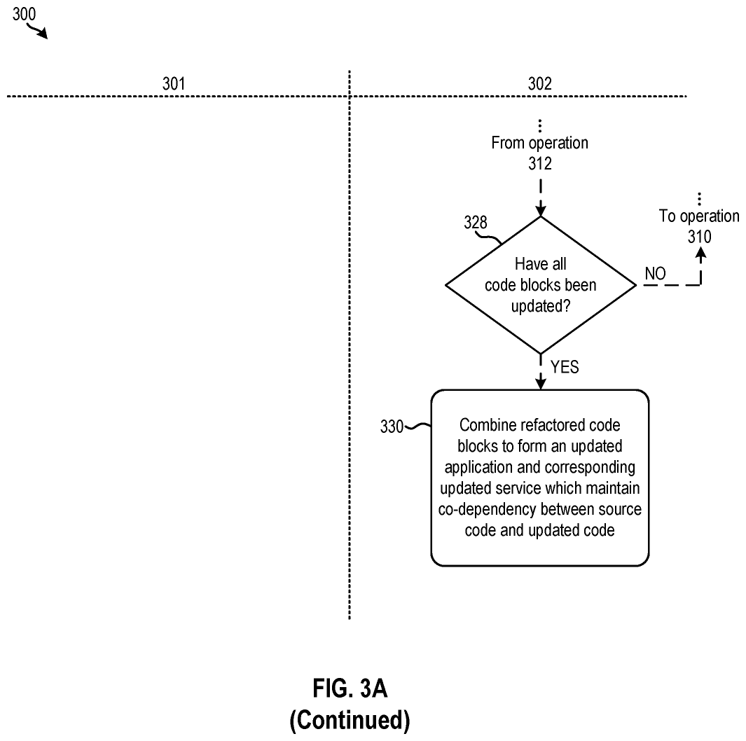

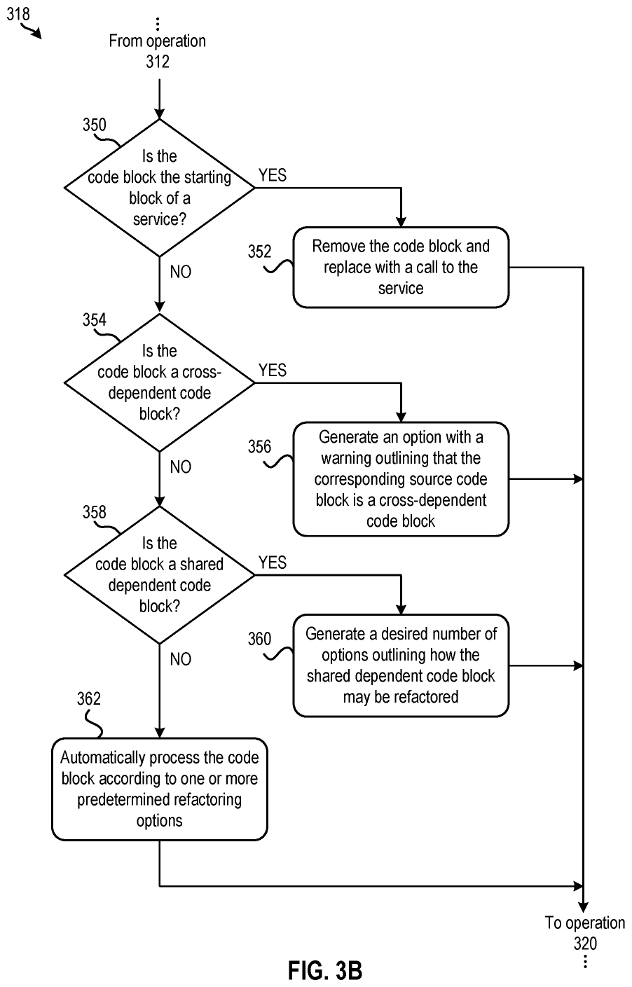

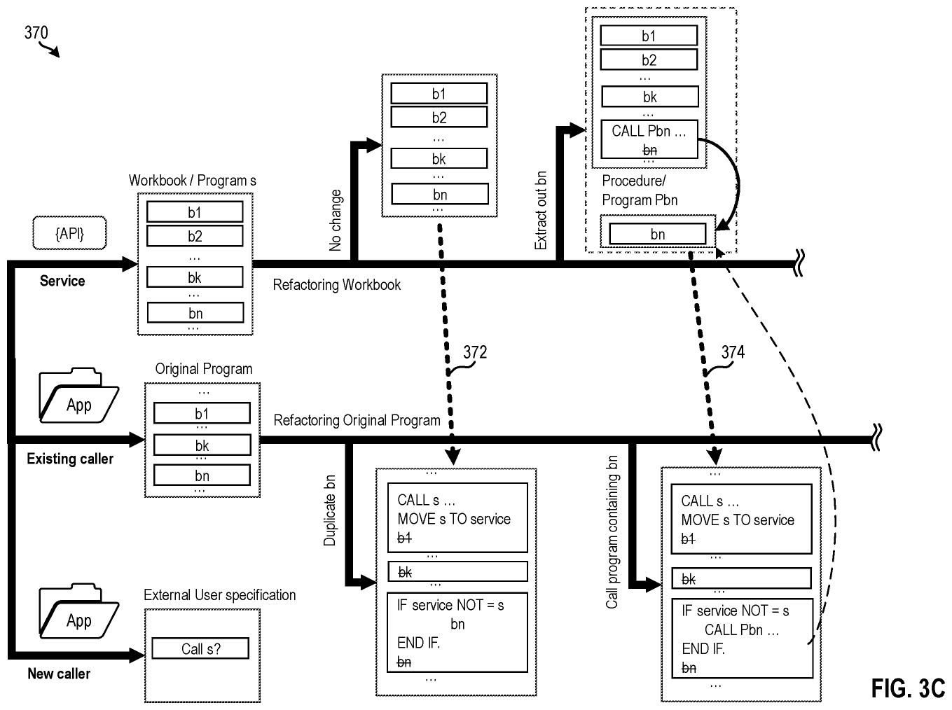

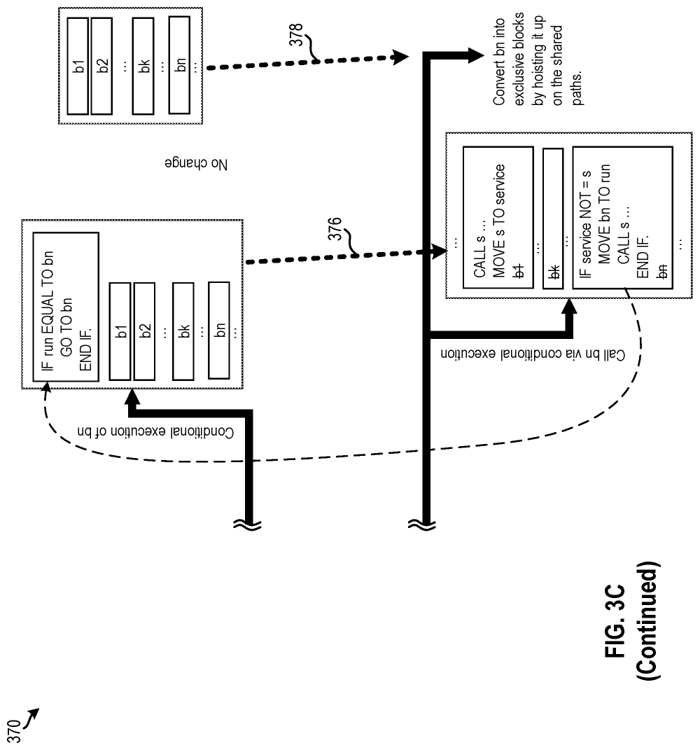

Referring momentarily to FIG. 2B, an incremental source code refactoring process 250 is illustrated in accordance with one approach. As an option, the present incremental source code refactoring process 250 may be implemented in conjunction with features from any other approach listed herein, such as those described with reference to the other FIGS., such as FIG. 2A. However, this process 250 and others presented herein may be used in various applications and/or in permutations which may or may not be specifically described in the illustrative approaches listed herein. Furthermore, the incremental source code refactoring process 250 presented herein may be used in any desired approach. Thus FIG. 2B (and the other FIGS.) may be deemed to include any possible permutation. It follows that the AI module 213 and/or processor 212 of FIG. 2B may be configured to perform one or more of the operations in the incremental source code refactoring process 250 of FIG. 2B and/or method 300 of FIG. 3A, e.g., as will be described in further detail below.

As shown in FIG. 2B, the incremental source code refactoring process 250 obtains source code 252 that is to be updated. The source code 252 may be accessed from memory (e.g., see data storage array 214 of FIG. 2A), received from a user (e.g., see user device 204 of FIG. 2A), submitted by an edge node (e.g., see edge node 206 of FIG. 2A) for supplemental processing, accessed at remote location connected to a network, etc.

The incremental source code refactoring process 250 initially inspects the accessed source code 252. In some approaches, one or more AI based models are used to inspect the source code 252. As noted above, the AI based models may be trained to identify dependent code blocks and generate options outlining how each dependent code block may be refactored such that co-existence of source code and updated code is maintained. Dependent blocks may also be identified using program analysis techniques (e.g., static and/or dynamic) in addition to using trained AI models in some approaches. The AI based models may also be trained to identify independent code blocks and automatically remove and/or refactor them using one or more predetermined processes.

Inspecting the accessed source code 252 detects source (e.g., existing) code blocks therein that are related (e.g., refer) to each other. For example, operation 254 includes identifying code blocks in the source code 252 that are part of a same service and/or are to be added to a same new service in the eventual refactored source code. As noted above, one or more AI based models may be used in operation 254 to identify the source code blocks being refactored in a given pass of the repeating operations 251. The code blocks may be identified based on an output generated by the AI based models as a result of evaluating the accessed source code 252 in some approaches. In other approaches, the code blocks refactored in a given iteration of the repeating operations 251 may simply correspond to a next service in the source code, be identified by a user, be based on an outcome of a last iteration, etc. In some approaches, the code blocks refactored in a given iteration of the repeating operations 251 may be randomly selected from the source code, selected in groups of code blocks of predetermined size(s), etc.

Proceeding from operation 254 to operation 256, there the source code blocks selected in operation 354 are evaluated to identify code blocks of interest. In other words, the portion of the source code being refactored in the current pass of the repeating operations 251 is inspected to locate code blocks of interest. The code blocks of interest include code that cannot be easily modified to implement updates. Thus, by locating these particular code blocks, specific steps may be taken such that the refactoring process as a whole is improved. For instance, the starting block of a service may be identified as a code block of interest. Service starting blocks that are identified may thereby be replaced with a call to the respective services, e.g., as will be described in further detail below.

Dependent code blocks may also be identified as blocks of interest in operation 256. As noted above, dependent code blocks include code blocks that have not been selected in a given service, but which have some relationship with (e.g., reference) the blocks that have been selected for the given service. It follows that in some situations, a dependent block may not be removed from source code without negatively impacting performance of at least some of the remaining code blocks in the source code. The dependent code blocks may include shared dependent blocks and/or cross-dependent blocks. Cross-dependent code blocks may further be a variable usage type or a control flow type depending on the situation. One or more AI based models that have been trained to identify dependent code blocks in source code may thereby be implemented in operation 256. In other approaches, performing operation 256 may involve identifying dependent blocks using program analysis techniques (e.g., static and/or dynamic) in addition to, or in place of, using trained AI models.

From operation 256, the process 250 proceeds to operation 258 where a determination is made. Operation 258 evaluates each of the code blocks being inspected in the given pass and determines whether each of the code blocks can be automatically refactored. In other words, operation 258 decides how each of the code blocks should be refactored (e.g., processed). According to a nonlimiting example, exclusive code blocks may be removed and/or modified as desired during refactoring. It should be noted that as used herein, “exclusive” is intended to refer to a service block that has neither shared dependency, nor cross dependency, with any non-service code blocks. Therefore, an exclusive code block can be removed from the original application and added to the service without performing any refactoring. Process 250 thereby proceeds from operation 258 to operation 260 for each code block determined as being capable of automatic refactoring, e.g., using one or more predetermined refactoring procedures. There, operation 260 includes causing the code block(s) determined as being capable of automatic refactoring to be refactored. As noted above, the automatic refactoring may be achieved using one or more refactoring procedures that have been selected and/or predetermined by a user, according to current performance trends, based on outputs generated by trained AI based models, etc.

From operation 260, the process 250 advances to operation 262. There, the refactored code blocks are incorporated into a partially updated copy of the source code. The partially updated copy of the source code includes a partially updated application 262A and a collection of partially updated services 262B. Each of the refactored code blocks received at operation 262 may thereby be added to a respective one of the partially updated application 262A and the partially updated services 262B. In some approaches, the partially updated application 262A includes a partially updated (e.g., modernized) polyglot application. In some approaches, the partially updated application 262A may serve as an accumulation of dependent and/or exclusive source code blocks that do not correspond to a service, and which have been refactored. In some approaches, the partially updated services 262B may include an accumulation of dependent and/or exclusive source code blocks that correspond to a service, and which have been refactored.

Returning to operation 258, the process 250 advances to operation 264 for each code block determined as not being capable of automatic refactoring. In other words, each source code block that can be refactored in multiple different ways may be evaluated further. In some approaches, operation 258 may thereby include determining whether each code block is one of the blocks of interest identified in operation 256, the blocks of interest being advanced to operation 264. Looking to operation 264, a number of options are generated outlining how each of the code blocks may be refactored such that co-existence of source code and updated code is ensured while also maintaining functionality of the code as a whole. In other words, operation 264 produces various options, each of which outlines how a code block (e.g., dependent code block) can be refactored to support co-existence of source code and updated code.

The generated options may be transmitted to a user (e.g., developer) associated with the code update being performed in some approaches. The generated options may thereby be sent in response to an initial code refactoring request that was received. In other approaches, the generated options may be input into one or more additional AI based models that have been trained to evaluate a number of possible refactoring options and select a most desirable option given the situation based on a number of factors, e.g., such as past performance, code language, security measures implemented in the source code, etc.

Proceeding to operation 266, responses indicating specific refactoring options to use while processing the code blocks are received. In other words, the responses received in operation 266 include a selection of one or more of the options that were originally sent to offer potential refactoring processes. The responses may be received from a user, one or more AI based models, running programs, etc. The code blocks determined as not being capable of automatic refactoring may thereby be refactored as outlined in the options that are ultimately selected. Operation 266 thereby produces refactored code blocks that are added to the partially updated application 262A and collection of partially updated services 262B in operation 262.

As noted above, operations 251 may be repeated in an iterative fashion such that each portion of the source code 252 is refactored incrementally. In other words, each time process 250 circles back and operation 254 is repeated, a different set of code blocks are evaluated and refactored. In some iterations, code blocks corresponding to a different service are processed each repetition of the operations 251. This allows the refactoring to be performed in incremental steps such that the updated code 268 is processed gradually over several iterations. This desirably ensures a mutual consistency between the source code 252 and any updated code blocks in the updated application 268A and/or collection of updated services 268B, e.g., as will be described in further detail below.

Returning now to FIG. 2A, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

In some approaches, data and/or code modifications may be submitted by user 205 using user device 204 and central server 202. For instance, updates to data and/or source code itself may be received from user 205 through user device 204 for implementation at central server 202. The updates may be received as a result of the user 205 using one or more applications, software programs, temporary communication connections, etc., that may be running on the user device 204. For example, the user 205 may use user device 204 to enter (e.g., type) new code into a command prompt and upload the new code to be added into existing code stored in memory of the data storage array 214 at central server 202.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include any desired number and/or type of AI-based models, e.g., such as machine learning models, deep learning models, neural networks, etc. However, in preferred approaches the AI module 238 includes models that have been trained to assist in updating code blocks as described herein. For instance, the AI module 238 preferably includes AI based models that have been trained to identify dependent code blocks and generate options outlining how each dependent code block may be refactored such that co-existence of source code and updated code is maintained. In other approaches, generating options outlining refactoring options and/or identifying the dependent code blocks themselves may involve using program analysis techniques (e.g., static and/or dynamic) in addition to using trained AI models. AI module 238 and/or controller 217 may thereby be configured to perform one or more of the operations in method 300 of FIG. 3A.

Looking now to FIG. 3A, a flowchart of a computer-implemented method 300 for refactoring a number of source code blocks is illustrated in accordance with one approach. The operations in method 300 are able to perform the refactoring more efficiently than previously achievable by systematically refactoring extracted services as well as source code from which the services are extracted in incremental steps. Method 300 is thereby able to address co-existence challenges within systems by ensuring mutual consistency between the source code and any extracted services. Moreover, approaches herein are capable of refactoring pure legacy code and/or partially updated polyglot legacy code in a manner that enables co-existence with the updated logic of the legacy application that have cross and/or shared dependencies.

The method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions. Each of the steps of the method 300 may further be performed by any suitable component of the operating environment. For example, the nodes 301, 302 shown in the flowchart of method 300 may correspond to one or more processors positioned at a different location in a distributed system. Moreover, each of the one or more processors are preferably configured to communicate with each other.

In various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3A includes different nodes 301, 302, each of which represent one or more processors, controllers, computer, etc., positioned at a different location in a distributed system. Node 301 may include one or more processors which are located in a user device connected to a network in a distributed system (e.g., see processor 216 of FIG. 2A above). In another approach, node 301 may include one or more processors which are located at an edge node that is connected to a network in a distributed system (e.g., see controller 217 of FIG. 2A above). Moreover, node 302 may include one or more processors which are located at a central server of a distributed system (e.g., see processor 212 of FIG. 2A above). Accordingly, commands, code, data, metadata outlining code updates, etc. may be sent between the nodes 301, 302 depending on the approach. It should also be noted that the various processes included in method 300 are in no way intended to be limiting, e.g., as would be appreciated by one skilled in the art after reading the present description. For instance, data sent from node 302 to node 301 may be prefaced by a request sent from node 301 to node 302 in some approaches.

As shown, operation 304 is performed at node 301. There, operation 304 includes submitting a request to update source code blocks. In other words, operation 304 includes submitting information (e.g., instructions, commands, metadata, etc.) that corresponds to performing a code update of a desired size. Depending on the approach, the code update may be configured (e.g., designed) to add a feature to a software program that corresponds to the code, address an issue identified in the code, reflect previous performance, to reflect results generated by machine learning models based on evaluation(s) performed on source code and/or code updates, etc. It follows that the number of code blocks that are ultimately updated as a result of submitting the information may also vary.

Updating the source code blocks preferably includes refactoring. Accordingly, the request submitted in operation 304 may include a refactoring request. Depending on the approach, the refactoring request may be submitted using a direct communication link with a server that has access to the source code, a user interface, a web interface configured to generate and maintain communication channels between the user and an administrator, etc.

As shown, the request is sent from node 301 to node 302 in operation 306. The request preferably includes information (e.g., metadata) that is sufficient to identify one or more source code blocks that are to be updated. According to some approaches, the information includes an identification (ID) of each code block requested to be updated. The code blocks being updated may correspond to an Integrated Development Environment (IDE) in some approaches. Accordingly, the IDs that may be received in operation 306 are preferably compatible with an IDE constructed to implement the code updates, e.g., as would be appreciated by one skilled in the art after reading the present description.

In response to receiving the request at node 302, method 300 advances to operation 308. There, operation 308 includes accessing the source code blocks that correspond to the request received in operation 306. In some approaches, the source code blocks may be received in operation 306 along with the request. The request may also be received along with information (e.g., metadata) that describes the updates to the source code that are being requested. Accordingly, operation 308 may simply include inspecting information received from node 301. In other approaches, operation 308 includes accessing the source code blocks from memory, requesting access to the source code blocks, decrypting the source code blocks, decompressing the source code blocks, etc., or any other pre-processing steps that may be taken. Additionally, one or more pre-processing (e.g., pre-refactoring) assumptions may be made that impact how the refactoring is ultimately performed. For example, assumptions may be made in the workbook (e.g., code blocks selected by the user). One such assumption may outline that in the workbook, the initial block is where a user intends to reference or call the extracted blocks from. Another assumption may be that the user selects the whole control structure for syntactic integrity. Still another assumption may be that the order of the code blocks from the original application are operationally kept the same.

From operation 308, method 300 advances to operation 310 in response to gaining access to the source code blocks. There, operation 310 includes evaluating the source code blocks and identifying code blocks of interest therein. As noted above, code blocks of interest may include the first block of a service, shared dependent code blocks, cross-dependent code blocks, and other types of code blocks that may not be easily modified to implement updates, e.g., such as being extracted from source code blocks and placed into a new service. For instance, cross-dependent code blocks may further be a variable usage type or a control flow type depending on the situation. According to an example, variable usage cross-dependent code blocks may be defined by the following situation: (i) blocks b and block b′ contain usage of the same variable where both usages are not reads, and (ii) the extraction of b will change the original order of b and b′. According to another example, control flow cross-dependent code blocks may be defined by the following situation: block b′ has a control-flow altering operation that bypasses execution of b, where the control-flow altering operations include GO TO, STOP RUN, exit( ), etc. By locating particular code blocks of interest, specific steps may be taken such that the refactoring process as a whole is improved.

It follows that operation 310 may include evaluating the source code blocks and identifying dependent code blocks therein. In some approaches, one or more AI based models may be trained to identify dependent code blocks in source code and/or generate a number of options outlining how each identified dependent code block may be refactored such that source code and updated code may co-exist. In other approaches, generating options outlining refactoring options and/or identifying the dependent code blocks themselves may involve using program analysis techniques (e.g., static and/or dynamic) in addition to using trained AI models, e.g., as will be described in further detail below.

Proceeding to operation 312, a determination is made with respect to each of the source code blocks evaluated in operation 310. There, operation 312 evaluates each of the code blocks being inspected in the given iteration of the operations and determines whether each of the code blocks can be automatically refactored. In other words, operation 312 decides how each of the code blocks should be refactored (e.g., updated). According to a nonlimiting example, exclusive code blocks may be removed from the underlying source code blocks and/or modified as desired during refactoring without impacting performance of other source code blocks. In comparison, code blocks with shared dependencies and/or cross-dependencies are not easily extractable and/or refactorable.

Method 300 thereby proceeds from operation 312 to operation 314 for each code block determined as being capable of automatic refactoring (e.g., exclusive). There, operation 314 includes causing the code block(s) determined as being capable of automatic refactoring to be refactored. As noted above, the automatic refactoring may be achieved using one or more refactoring procedures that have been predetermined by a user, according to current performance trends, based on outputs generated by trained AI based models, designated for the exclusive source code blocks, etc., depending on the approach. In preferred approaches, the distinction between shared and cross-dependent code blocks may be used to automatically make refactoring decisions in some approaches when faced with these “unambiguous” cases associated with the automatic refactoring.

From operation 314, method 300 advances to operation 316. There, the refactored code blocks are incorporated into a partially updated copy of the source code. The partially updated copy of the source code includes a partially updated application and a collection of partially updated services. Each of the refactored code blocks received at operation 316 may thereby be added to a respective one of the partially updated application and the partially updated services. In some approaches, the partially updated application includes a partially updated polyglot application. In some approaches, the partially updated application serves as an accumulation of dependent and/or exclusive source code blocks that do not correspond to a service, and which have been refactored. In some approaches, the partially updated services may include an accumulation of dependent and/or exclusive source code blocks that correspond to a service, and which have been refactored.

Returning to operation 312, method 300 advances to operation 318 for each code block determined as not being capable of automatic refactoring. In other words, each source code block that can be refactored in multiple different ways may be evaluated further to determine the preferred way of refactoring a source code block. In some approaches, operation 318 may thereby include determining whether each code block is one of the blocks of interest identified in operation 310, the blocks of interest being advanced to operation 318. Looking to operation 318, a number of options are generated outlining how each code block determined in operation 312 as not being capable of automatic refactoring, may be refactored.

The options are preferably generated such that they outline refactoring steps that support the co-existence of source code and updated code while also maintaining functionality of the code as a whole, allowing for improved software modernization. In other words, operation 318 produces various options, each of which outlines how a code block (e.g., dependent code block) can be refactored to support co-existence of source code and updated code. In some approaches, at least some of the options may be generated (e.g., output) by one or more trained AI based models that are configured to evaluate source code blocks (e.g., code blocks of interest) and generate possible ways of refactoring the code blocks based on how code is being updated. The AI based models may further be configured to convert the generated refactoring options into a different format, e.g., such as metadata, that may be more easily transmitted and/or interpreted at a target location. It should also be noted that the AI based models may be trained using training data sets and/or over time as code blocks are refactored.

According to one example, which is in no way intended to be limiting, refactoring information, including generated refactoring options, may be described using the following metadata and/or structure:
Code block(s) being refactored
   <block name>
      Line numbers to be refactored: . . .
      Proposed refactoring techniques
         Original code refactoring
         Action: “Edit”/“Delete/Comment”/“No change”
         Information: . . .
         Refactored code: . . .
         Service refactoring
         Action: “Edit”/“Delete/Comment”/“No change”
         Information: . . .
         Refactored code: . . .
. . . .

As noted above, refactoring options may be generated for dependent code blocks. Accordingly, in some approaches operation 318 includes generating refactoring options for one or more cross-dependent source code blocks identified in the code blocks being evaluated in a current iteration (e.g., pass) of method 300. In some approaches, operation 318 includes generating refactoring options for one or more shared dependent source code blocks identified in the code blocks being evaluated in a current iteration (e.g., pass) of method 300. Performing operation 318 may thereby depend on the types of code blocks being refactored.

Referring momentarily to FIG. 3B, exemplary sub-operations of generating refactoring options for dependent code blocks are illustrated in accordance with one approach. It follows that one or more of these sub-operations may be used to perform operation 318 of FIG. 3A. Moreover, the sub-operations in FIG. 3B may be repeated for each code block having refactoring options generated. However, it should be noted that the sub-operations of FIG. 3B are illustrated in accordance with one approach which is in no way intended to be limiting.

As shown, sub-operation 350 includes determining whether a present code block (e.g., the code block currently being processed) is the starting block of a service. In response to determining the present source code block is the starting block of a service, the flowchart proceeds to sub-operation 352 where the present code block is removed and replaced with a call to the service.

Returning to sub-operation 350, the flowchart proceeds to sub-operation 354 from sub-operation 350 in response to determining that the present code block is not the first code block of a service. There, sub-operation 354 includes determining whether the present code block is a cross-dependent code block. In some approaches, sub-operation 354 includes determining whether any preceding cross-dependent block(s) are included in a service being evaluated. Moreover, cross-dependent code blocks may further be of a variable usage type, or a control flow type depending on the situation. Thus, sub-operation 354 may further include determining what specific type of cross-dependent code block the present code block is.

In response to determining that the present code block is a cross-dependent code block, the flowchart proceeds to sub-operation 356. There, sub-operation 356 includes generating an option with a warning outlining that the corresponding source code block is a cross-dependent code block. The warning preferably further outlines that the cross-dependent code block should be added to (e.g., duplicated into) an at least partially updated service. The warning may thereby include one or more instructions that ultimately cause the cross-dependent code block to be duplicated into the partially updated service as a result of being selected for implementation.

Returning now to sub-operation 354, the flowchart proceeds to sub-operation 358 from sub-operation 354 in response to determining that the present code block is not a cross-dependent code block. There, sub-operation 358 includes determining whether the present code block is a shared dependent code block. In some approaches, sub-operation 358 includes determining whether any non-service blocks are calling (e.g., reference or have a pointer to) a service block. However, any desired steps may be taken to determine whether the present code block is a shared dependent code block.

In response to determining that the present code block is a shared dependent code block, the flowchart proceeds from sub-operation 358 to sub-operation 360. There, sub-operation 360 includes generating a desired number of options outlining how the shared dependent code block may be refactored. The number of refactoring options that are generated for a given code block being updated may depend on the type of code block, user preferences, real-time performance, etc. Thus, the number and/or type of refactoring options generated in sub-operation 360 may vary. In some approaches, the refactoring options outline simply duplicating the given shared dependent source code block into the updated code. In some approaches, the refactoring options outline using the given shared dependent source code block to produce a new service. In some approaches, the refactoring options outline creating conditional execution of the given shared dependent source code block. In some approaches, the refactoring options outline hoisting the given shared dependent source code block to make it executable. It follows that a number of options may be available to refactor the present code block.

Referring momentarily to FIG. 3C, several different refactoring options are shown in accordance with an in-use example 370, which is in no way intended to be limiting. For instance, source code is separated into a Service portion having Workbooks and/or Programs, an Existing caller portion which includes the remaining portions of the Original Program (source code), and a New caller portion having any external user specification(s). The Workbooks and/or Programs as well as the Original Program include code blocks “b1” which indicate the start of a workbook, code blocks “bk” which indicate blocks that are exclusive to the service, and code blocks “bn” which indicate shared code blocks.

As noted above, refactoring is performed on the Workbooks and/or Programs as well as the Original Program. The type of refactoring that is implemented may differ depending on the approach. Thus, several different options may be suggested before a final refactoring process is selected and implemented, e.g., as described herein. A first suggested refactoring technique 372 simply outlines how the given shared dependent source code block may be duplicated into the updated code. The second suggested refactoring technique 374 outlines how a shared dependent source code block may be used to produce a new service. The third suggested refactoring technique 376 outlines how to implement conditional execution of the given shared dependent source code block. Furthermore, the fourth suggested refactoring technique 378 outlines how to hoist the given shared dependent source code block in order to make it executable. While four different options are shown as being produced in FIG. 3C, any desired number of refactoring options may be made available to refactor a code block depending on the approach.

Returning again to sub-operation 358 of FIG. 3B, the flowchart may proceed to sub-operation 362 in response to determining the present code block is not a shared dependent code block. There, sub-operation 362 includes automatically processing the code block according to one or more predetermined refactoring options. While the flowchart of FIG. 3B is shown as returning to operation 320 of FIG. 3A from sub-operations 352, 356, 360, 362, it should be noted that the sub-operations of FIG. 3B may be repeated for a next code block being processed. Thus, FIG. 3B may be performed any desired number of times.

Returning now to FIG. 3A, operation 320 includes transmitting the generated options from node 302 back to node 301. In response to receiving the generated options, operation 322 includes evaluating the options that are available for each code block, and select a preferred implementation for each code block. The generated options may thereby be sent in response to an initial code refactoring request that was received from node 301. In some approaches, the options received at node 301 may be evaluated by a user (e.g., developer) associated with the code update being performed. The user may further select a preferred refactoring implementation for each code block. However, in other approaches the options received at node 301 may be input into one or more additional AI based models that have been trained to evaluate a number of possible refactoring options and select a most desirable option given the situation based on a number of factors, e.g., such as past performance, code language, security measures implemented in the source code, etc.

Proceeding to operation 324, responses indicating specific refactoring options to use while processing the code blocks are returned from node 301 to node 302. In other words, node 302 receives one or more of the options that have been selected by the user as a result of the evaluation performed at operation 322. Accordingly, node 301 causes the specific refactoring options to be implemented at node 302. As noted above, the responses may be received in operation 324 from a user, one or more AI based models, running programs, etc. Operation 326 thereby includes refactoring the code blocks determined as not being capable of automatic refactoring, as outlined in the selected options. In other words, the options selected at node 301 are returned to node 302 and used to refactor each of the respective code blocks. Operation 326 thereby produces refactored code blocks that may be added to the partially updated application and collection of partially updated services.

Accordingly, method 300 advances from operation 326 to operation 316. As noted above, operation 316 incorporates the refactored code blocks into a partially updated copy of the source code, which preferably includes a partially updated application and a collection of partially updated services. Each of the refactored code blocks received from operation 326 at operation 316 may thereby be added to a respective one of the partially updated application and the partially updated services, e.g., as would be appreciated by one skilled in the art after reading the present description.

From operation 316, method 300 advances to operation 328 where a determination is made as to whether all code blocks have been updated. In other words, operation 328 includes determining whether the source code has been fully updated, or if additional code blocks have not yet been refactored. In response to determining that the source code has not been fully updated, method 300 returns to operation 310 such that a new set of source code blocks may be evaluated and refactored. As noted above, method 300 implements incremental refactoring such that the source code is processed gradually over several iterations. Method 300 is thereby able to address co-existence challenges within systems by ensuring mutual consistency between the source code and any extracted services. Moreover, approaches herein are capable of refactoring pure legacy code and/or partially updated polyglot legacy code in a manner that enables co-existence with the updated logic of the legacy application that have cross and/or shared dependencies.

It follows that a number of the operations in method 300 may be repeated in an iterative fashion such that each portion of the source code is refactored. Returning to operation 328, method 300 exits the repeating cycle and proceeds to operation 330 in response to determining that the source code has been fully updated. There, operation 330 includes combining the various refactored code blocks to form an updated application and corresponding updated service which maintain co-dependency between source code and updated code. Accordingly, operation 330 includes combining the refactored exclusive source code blocks and refactored dependent source code blocks to form an updated application and corresponding updated service.

It follows that method 300 is desirably able to merge codependent source code with selected code and/or services without blindly automating the process. For instance, blind deletion of shared dependent source code blocks is undesirable. Rather, suggested refactoring alternates may be used to ultimately refactor one or more of the shared dependent source code blocks as described herein. Method 300 is also desirably able to automatically refactor either pure legacy code or partially updated polyglot legacy code to enable co-existence with the updated logic of the legacy application that have cross and/or shared dependencies. This refactoring process is performed incrementally and continuously until the desired updated state is achieved by repeating various ones of the operations in method 300.

It should be noted that while method 300 is described in detail above, additional considerations may be taken into account while determining how a code block is refactored. For example, certain code blocks may be sufficiently small that simply copying them into the updated code is simpler than evaluating how it should be refactored. Accordingly, a size of each code block evaluated may be compared against a predetermined range to determine whether the code block is small enough to forego further evaluation. Similarly, certain types of code blocks may be simply copied into updated code. For example, code blocks that include initializations are preferably maintained even in the updated code. Accordingly, the type of each code block evaluated may be inspected to determine whether the code block should simply be copied, or refactored using different steps, e.g., as would be appreciated by one skilled in the art after reading the present description.

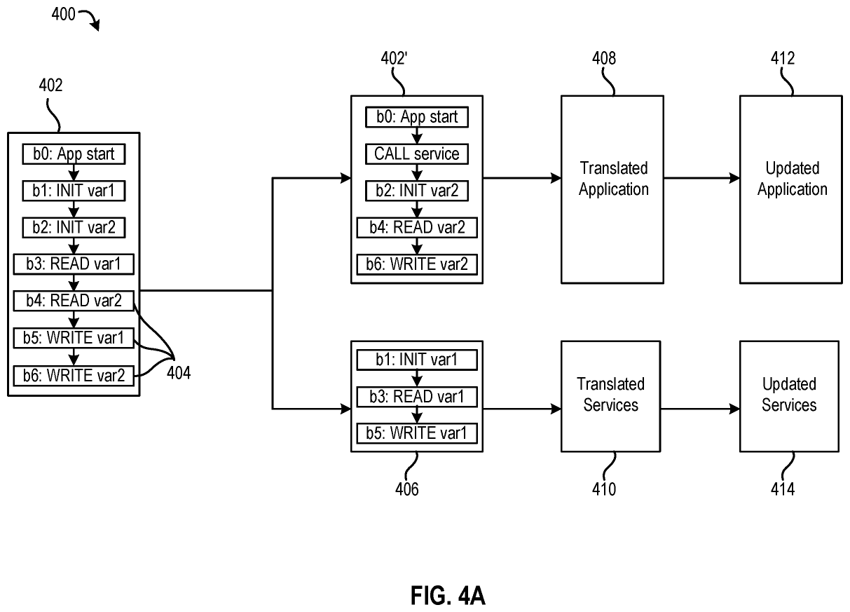

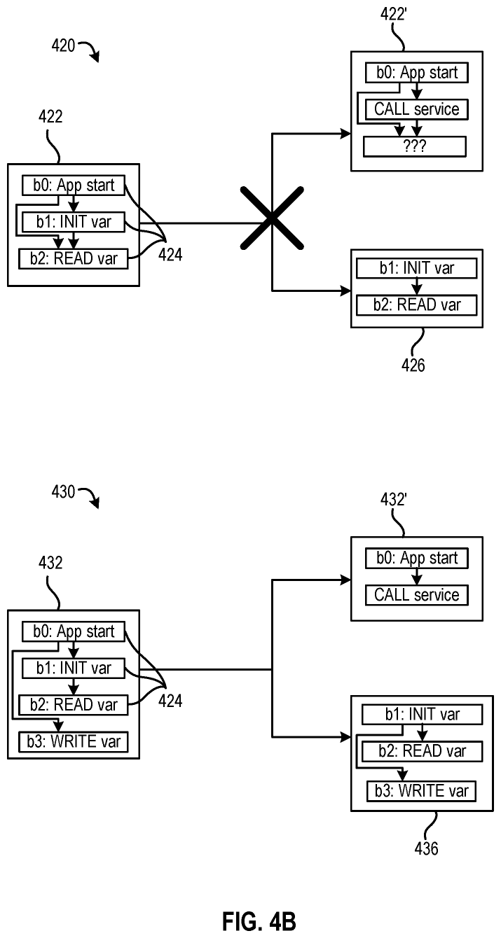

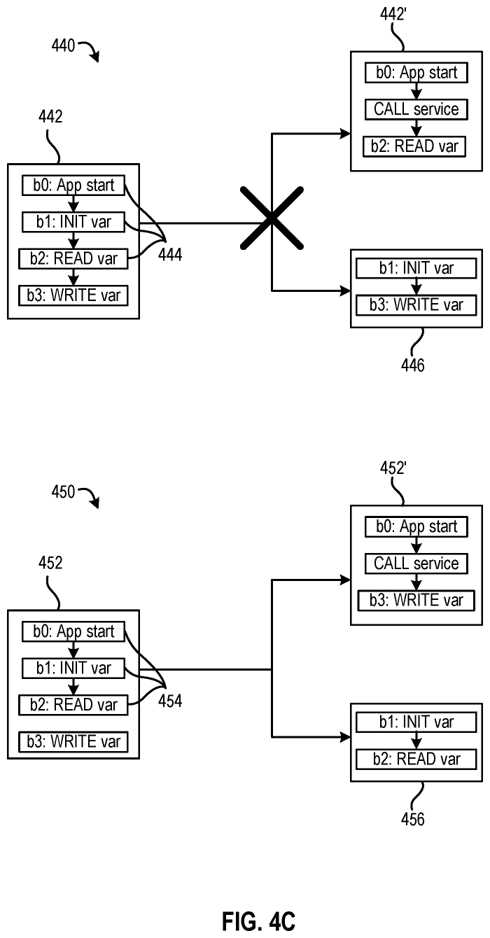

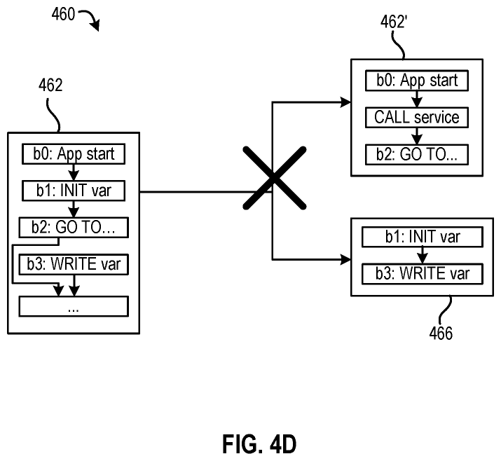

Looking now to FIG. 4A, a representational view of a progression 400 implementing incremental service extraction is depicted in accordance with an in-use example. The progression 400 is thereby intended to serve as a non-limiting example of how incremental service extraction may be performed in any of the approaches herein.

As shown, the source code 402 is in the form of an application which includes a number of source code blocks 404. A subset of the source code blocks 404 are identified as corresponding to each other (e.g., being associated with the same service) and extracted from a remainder of the source code 402′ to create an extracted service 406. Additional services may continue to be extracted from a remainder of the source code 402′, ultimately forming a translated application 408 and translated services 410. The translated application 408 may further be refactored (e.g., using incremental refactoring as described herein) to form an updated application 412. Similarly, the translated services 410 (along with other translated services) may be refactored and combined to form updated services 414.

Looking now to FIG. 4B, a representational view of progressions 420, 430 depicting shared vs. non-shared dependent code blocks in accordance with an in-use example. The progressions 420, 430 are thereby intended to serve as a non-limiting examples of how dependent code blocks may be used in any of the approaches herein. As shown, the first source code 422 is in the form of an application which includes a number of source code blocks 424. A subset of the source code blocks 424 are identified as corresponding to each other (e.g., being associated with the same service) and an attempt to extract the subset from a remainder of the source code 422′ to create an extracted service 426. However, in situations where a selected code block is shared with (e.g., reachable from) service blocks as well as non-service blocks, then the selected block cannot be cleanly extracted. In other words, code block b2 is a shared block because it can be executed separate from the service also.

In comparison, the second source code 432 is in the form of an application which includes a number of source code blocks 434. A subset of the source code blocks 434 are identified as corresponding to each other (e.g., being associated with the same service) and an attempt to extract the subset from a remainder of the source code 432′ to create an extracted service 436. Not all blocks with an extra incoming edge are shared block. For example, in this situation, while code block b3 has an extra incoming edge, it is not a shared block. Thus, not all blocks with an extra incoming edge are shared blocks.

Additional services may continue to be extracted from a remainder of the source code 402′, ultimately forming a translated application 408 and translated services 410. The translated application 408 may further be refactored (e.g., using incremental refactoring as described herein) to form an updated application 412. Similarly, the translated services 410 (along with other translated services) may be refactored and combined to form updated services 414.

In other approaches, a workbook code block may be non-shared for the workbook in situations where it can be removed from the application and placed only in the workbook. In other words, a workbook block “b” is a shared block in situations where there exists an application path that reaches block b without passing through the first statement extracted into the workbook.

As for code blocks that have duplicate usages, they may be extracted from the workbook service. While this may create too many programs and copybooks per service (at most, one per code block), and re-compute requests/responses create separate copybooks for each extracted block, this is desirable in situations where the initial requirements include that “export blocks as-is” (e.g., rather than “export to a single program”), as modularity is supported in this refactoring. Conditions may also be placed on these blocks in the workbook service which maintains the initial standard of “export to a single program.” Separate copybooks also need not be created for each block.

Looking now to FIG. 4C, a representational view of progressions 440, 450 depicting variable dependent vs. variable exclusive code blocks in accordance with an in-use example. The progressions 440, 450 are thereby intended to serve as a non-limiting examples of how dependent code blocks may be used in any of the approaches herein.

As shown, progressions 440 includes an attempt to extract code blocks {b1, b3} from first source code blocks 442 to form updated source code 442′ and extracted service 446. However, the code blocks 444 are variable dependent and cannot be extracted. Specifically, if block b3 is extracted but block b2 is not extracted, the behavior of the refactored application is altered because b3 will be called before b2.

In contrast, progression 450 shows that it is possible that a variable dependent block can be removed from the base application. For example, Blocks b2 and b3 454 in source code 452 use the same variable “var”, but even in situations where only code block b2 is selected for extraction to a service 456 and code block b3 is not selected and remains in updated source code 452′ (as shown), this does not lead to logic faults.

Looking now to FIG. 4D, a representational view of a progression 460 depicting control dependent code blocks in accordance with an in-use example. The progression 460 is thereby intended to serve as a non-limiting example of how dependent code blocks may be used in any of the approaches herein.

As shown, if a block located between the selected blocks is not selected in the service and it contains a control-flow altering operation, then the selected blocks cannot be extracted. Specifically, source code 462 includes control block b2 includes a control-flow altering operation and is maintained in the updated source code 462′ rather than being selected in the service 466. Accordingly, the proposed extraction shown cannot be performed.

Approaches herein are desirably able to automatically refactor either pure legacy code or partially updated polyglot legacy code to enable co-existence with the updated logic of the legacy application that have cross and/or shared dependencies. This refactoring process is performed incrementally and continuously until the desired updated state is achieved. Co-existence is achieved in the approaches herein by automatically identifying code blocks that cannot be extracted, e.g., such as dependent code blocks that cannot be easily removed from the original application and placed into a new service. These approaches area able to recognize shared dependent code blocks as well as cross-dependent code blocks (in terms of variable usage as well as control flow). Moreover, one or more AI based models may be used to generate a number of options outlining different ways that dependent code blocks may be refactored to enable co-existence, e.g., as would be appreciated by one skilled in the art after reading the present description.

Once again, approaches herein are desirably able to refactor a number of source code blocks more efficiently than previously achievable by systematically refactoring extracted services as well as source code from which the services are extracted in incremental steps. Approaches are able to refactor partially modernized legacy code to facilitate new and improved computer program parts (e.g., modernized functions) to work alongside the legacy code by maintaining co-dependency to maintain smooth transition and ongoing maintenance of the system. This feature allows incremental modernization of legacy applications such that both the new and old co-exist and work together. The advantage of this approach is risk mitigation and securing return on investment early in the modernization process.

Approaches are also able to analyze and compute multiple code sharing and code dependency aspects to enable automated refactoring. This desirably reduces the cognitive load in the developer to identify such cases and act upon them. Furthermore, approaches herein can automatically identify non-exclusive code blocks from the original application placed into a new service. This desirably provides a clear separation between the code blocks which are exclusive to the new service (and hence can be retracted), and the code blocks which cannot be retracted without resolving some dependency issue(s). While this identification can be tedious, slow, and error-prone, implementing trained models (e.g., AI based models) helps with overall productivity during the modernization process by ensuring speed, coverage and correctness in the identification process, e.g., as would be appreciated by one skilled in the art after reading the present description.

As described above, approaches herein are able to recognize both shared dependent code blocks and cross-dependent code blocks (both in terms of variable usage and control flow) in source code blocks. This assists in determining the co-dependent a new service will have on the legacy code blocks. Exclusive blocks can also be identified, and for the dependent blocks, the nature and extent of dependency may further be determined. The advantage of this feature is that it automates the process of computing co-dependent code blocks in the new and the old portions of an application which otherwise is extremely time-consuming, involves input from highly skilled and experienced developers, and is prone to errors. Rather, approaches herein use the distinction between shared dependent and cross-dependent code blocks to automatically take refactoring decisions in unambiguous cases, and provide automated refactoring options (e.g., suggestions) on how to handle such dependent code blocks while also enable co-existence of the source code and updated code. This desirably reduces the cognitive load in the developer to identify such cases and then act upon them.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on-demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM) for refactoring a number of source code blocks, comprising:
evaluating the source code blocks;
identifying dependent and exclusive ones of the source code blocks;
automatically causing the exclusive source code blocks to be refactored;
generating options outlining how the dependent source code blocks can be refactored;
transmitting the options to a user;
in response to receiving a selection of one or more of the options from the user, causing the dependent source code blocks to be refactored as outlined in the selected one or more options; and
combining the refactored exclusive source code blocks and refactored dependent source code blocks to form an updated application and corresponding updated service.

2. The CIM of claim 1, wherein the identifying of the dependent and exclusive source code blocks includes, for each of the source code blocks evaluated:
determining whether a given source code block is a starting block of a service; and
in response to determining the given source code block is the starting block of a service, replacing the given source code block with a call to the service.

3. The CIM of claim 1, wherein the dependent source code blocks include shared dependent blocks and/or cross-dependent blocks.

4. The CIM of claim 3, wherein the generating of the options outlining how the dependent source code blocks can be refactored includes:
producing a warning in response to determining a given dependent source code block is a cross-dependent source code block, the warning outlining that the given dependent source code block will be added to the updated service.

5. The CIM of claim 3, wherein the generating of the options outlining how the dependent source code blocks can be refactored includes:
producing one or more refactoring alternates in response to determining a given dependent source code block is a shared dependent source code block, the one or more refactoring alternates being selected from the group consisting of: duplicating the given dependent source code block, using the given dependent source code block to produce a new service, creating conditional execution of the given dependent source code block, and hoisting the given dependent source code block.

6. The CIM of claim 1, wherein the source code blocks include standard code and/or partially updated polyglot code.

7. The CIM of claim 1, further comprising:
in response to determining a given source code block includes an initialization, causing the given source code block to be refactored by duplicating the given source code block into the updated application.

8. The CIM of claim 1, further comprising:
in response to determining a given source code block includes a number of lines therein that is outside a predetermined range, causing the given source code block to be refactored by duplicating the given source code block into the updated application.

9. A computer program product (CPP) for refactoring a number of source code blocks, comprising:
a set of one or more computer-readable storage media; and
program instructions, collectively stored in the set of one or more storage media, for causing a processor set to perform the following computer operations:
evaluate the source code blocks;
identify dependent and exclusive ones of the source code blocks;
automatically cause the exclusive source code blocks to be refactored;
generate options outlining how the dependent source code blocks can be refactored;
transmit the options to a user;
in response to receiving a selection of one or more of the options from the user, cause the dependent source code blocks to be refactored as outlined in the selected one or more options; and
combine the refactored exclusive source code blocks and refactored dependent source code blocks to form an updated application and corresponding updated service.

10. The CPP of claim 9, wherein the identifying of the dependent and exclusive source code blocks includes, for each of the source code blocks evaluated:
determining whether a given source code block is a starting block of a service; and
in response to determining the given source code block is the starting block of a service, replacing the given source code block with a call to the service.

11. The CPP of claim 9, wherein the generating of the options outlining how the dependent source code blocks can be refactored includes:
producing a warning in response to determining a given dependent source code block is a cross-dependent source code block, the warning outlining that the given dependent source code block will be added to the updated service.

12. The CPP of claim 9, wherein the generating of the options outlining how the dependent source code blocks can be refactored includes:
producing one or more refactoring alternates in response to determining a given dependent source code block is a shared dependent source code block, the one or more refactoring alternates being selected from the group consisting of: duplicating the given dependent source code block, using the given dependent source code block to produce a new service, creating conditional execution of the given dependent source code block, and hoisting the given dependent source code block.

13. The CPP of claim 9, wherein the source code blocks include standard code and/or partially updated polyglot code.

14. The CPP of claim 9, wherein the program instructions are for causing the processor set to further perform the following computer operations:
in response to determining a given source code block includes an initialization, cause the given source code block to be refactored by duplicating the given source code block into the updated application.

15. The CPP of claim 9, wherein the program instructions are for causing the processor set to further perform the following computer operations:
in response to determining a given source code block includes a number of lines therein that is outside a predetermined range, cause the given source code block to be refactored by duplicating the given source code block into the updated application.

16. A computer system (CS), comprising:
a processor set;
a set of one or more computer-readable storage media;
program instructions, collectively stored in the set of one or more storage media, for causing the processor set to perform the following computer operations for refactoring a number of source code blocks:
evaluate the source code blocks;
identify dependent and exclusive ones of the source code blocks;
automatically cause the exclusive source code blocks to be refactored;
generate options outlining how the dependent source code blocks can be refactored;
transmit the options to a user;
in response to receiving a selection of one or more of the options from the user, cause the dependent source code blocks to be refactored as outlined in the selected one or more options; and
combine the refactored exclusive source code blocks and refactored dependent source code blocks to form an updated application and corresponding updated service.

17. The CS of claim 16, wherein the identifying of the dependent and exclusive source code blocks includes, for each of the source code blocks evaluated:
determining whether a given source code block is a starting block of a service; and
in response to determining the given source code block is the starting block of a service, replacing the given source code block with a call to the service.

18. The CS of claim 16, wherein the generating of the options outlining how the dependent source code blocks can be refactored includes:
producing a warning in response to determining a given dependent source code block is a cross-dependent source code block, the warning outlining that the given dependent source code block will be added to the updated service.

19. The CS of claim 16, wherein the generating of the options outlining how the dependent source code blocks can be refactored includes:
producing one or more refactoring alternates in response to determining a given dependent source code block is a shared dependent source code block, the one or more refactoring alternates being selected from the group consisting of: duplicating the given dependent source code block, using the given dependent source code block to produce a new service, creating conditional execution of the given dependent source code block, and hoisting the given dependent source code block.

20. The CS of claim 16, wherein the source code blocks include standard code and/or partially updated polyglot code.

21. A computer-implemented method (CIM) for refactoring a number of source code blocks, comprising:
submitting a request to refactor the source code blocks, wherein the source code blocks include standard code and/or partially updated polyglot code;
receiving options outlining how dependent ones of the source code blocks can be refactored, wherein the dependent source code blocks include shared dependent blocks and/or cross-dependent blocks; and
in response to selecting one or more of the options outlining how dependent ones of the source code blocks can be refactored:
causing the dependent source code blocks to be refactored as outlined in the selected one or more options, and
causing the refactored dependent source code blocks to be combined with refactored exclusive source code blocks to form an updated application and corresponding updated service.

22. The CIM of claim 21, further comprising:
selecting one of the options that includes a warning outlining that a corresponding cross-dependent source code block will be added to the updated service.

23. The CIM of claim 21, further comprising:
selecting one of the options outlining that a corresponding shared dependent source code block can be refactored using one or more refactoring alternates, the one or more refactoring alternates being selected from the group consisting of: duplicating the given shared dependent source code block, using the given shared dependent source code block to produce a new service, creating conditional execution of the given shared dependent source code block, and hoisting the given shared dependent source code block.

24. A computer program product (CPP) for refactoring a number of source code blocks, comprising:
a set of one or more computer-readable storage media; and
program instructions, collectively stored in the set of one or more storage media, for causing a processor set to perform the following computer operations:
submit a request to refactor the source code blocks, wherein the source code blocks include standard code and/or partially updated polyglot code;
receive options outlining how dependent ones of the source code blocks can be refactored, wherein the dependent source code blocks include shared dependent blocks and/or cross-dependent blocks; and
in response to selecting one or more of the options outlining how dependent ones of the source code blocks can be refactored:
cause the dependent source code blocks to be refactored as outlined in the selected one or more options, and
cause the refactored dependent source code blocks to be combined with refactored exclusive source code blocks to form an updated application and corresponding updated service.

25. The CPP of claim 24, wherein the program instructions are for causing the processor set to further perform the following computer operations:
select one of the options outlining that a corresponding shared dependent source code block can be refactored using one or more refactoring alternates, the one or more refactoring alternates being selected from the group consisting of: duplicating the given shared dependent source code block, using the given shared dependent source code block to produce a new service, creating conditional execution of the given shared dependent source code block, and hoisting the given shared dependent source code block.
